(19) United States
(12) Patent Application Publication
(10) Pub. No.: US 2010/0153368 A1
(43) Pub. Date: Jun. 17, 2010

(54) Determining Query Referents for Concept Types in Conceptual Graphs

(75) Inventors: Bruce E. Peoples, State College, PA (US); Michael R. Johnson, State College, PA (US); Michael M. Smith, Aaronsburg, PA (US)

Correspondence Address: BAKER BOTTS LLP, 2001 ROSS AVENUE, 6TH FLOOR, DALLAS, TX, 75201-2980, US

(73) Assignee: RAYTHEON COMPANY, Waltham, MA (US)

(21) Appl. No.: 12/335,260

(22) Filed: Dec. 15, 2008

(51) Int. Cl. G06F 7/06; G06F 17/30

(52) U.S. Cl. 707/722; 707/E17.014

(57) ABSTRACT

In one embodiment, a method for determining referents for concept types in a conceptual graph includes generating a conceptual graph for a search query, the conceptual graph comprising a plurality of graph terms, identifying at least one graph term needing referents, identifying referents for each graph term needing referents by searching for instances where conceptually similar terms for graph terms needing referents are associated by conceptually similar terms for the linking concept term; and associating identified referents with the graph terms needing referents.

### TECHNICAL FIELD

This invention relates generally to the field of information technology and management and more specifically to concept types in conceptual graphs.

### BACKGROUND

A corpus of data may hold a large amount of information, yet finding relevant information may be difficult. Keyword searching is the primary technique for finding information. In certain situations, however, known techniques for keyword searching cannot find conceptually similar terms for concepts that the keywords represent.

### SUMMARY OF THE DISCLOSURE

In accordance with the present invention, disadvantages and problems associated with previous techniques may be reduced or eliminated.

According to one embodiment, a method for determining referents for concept types in a conceptual graph includes generating a conceptual graph for a search query, the conceptual graph including a plurality of graph terms. At least one graph term needing referents is identified, and referents for each graph term needing referents are identified by searching for instances where conceptually similar terms for graph terms needing referents are associated by conceptually similar terms for the linking concept term. Identified referents are associated with the graph terms needing referents.

Certain embodiments of the invention may provide one or more technical advantages. A technical advantage of one embodiment may be that query referents for concept types in concept graphs may be determined. In some embodiments, the query conceptual graph may include graph terms that represent concept types. Certain embodiments identify a set of terms conceptually similar to the graph terms. Conceptually similar terms for concept types needing referents may further be identified. A technical advantage of certain embodiments includes determining referents for specific concept types. Certain embodiments provide information necessary to discover instance information. Some embodiments provide for storage and use of referents determined. Another technical advantage of certain embodiments may include storing and using referents in future queries.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a system configured to conceptually expand terms of conceptual graphs;

FIGS. 2A and 2B illustrate examples of a query conceptual graph and a document conceptual graph, respectively;

FIG. 3 illustrates an example of an onomasticon that includes terms associated with a query conceptual graph;

FIG. 4 illustrates an example of an onomasticon that includes terms associated with a document conceptual graph;

FIG. 5 illustrates an example of a method for determining query referents for concept types in conceptual graphs.

FIG. 6 illustrates an example of a method for determining query return referents for concept types in conceptual graphs.

### DETAILED DESCRIPTION OF THE DRAWINGS

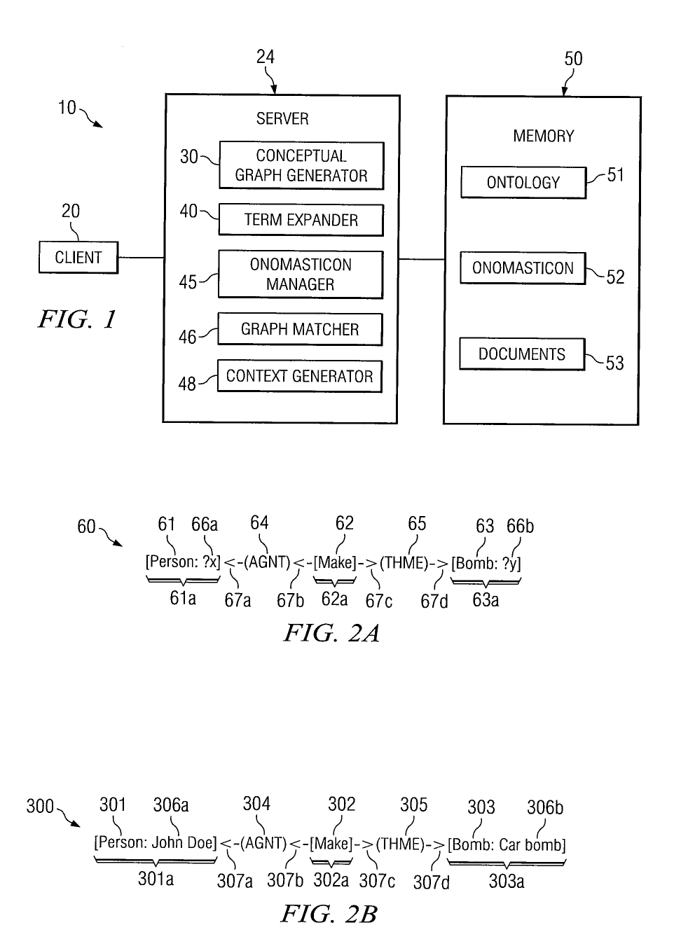

Embodiments of the present invention and its advantages are best understood by referring to FIGS. 1 through 6, like numerals being used for like and corresponding parts of the various drawings.

FIG. 1 illustrates one embodiment of a system 10 configured to determine query referents and/or query return referents for concept types in conceptual graphs. In certain embodiments, system 10 generates a query conceptual graph that may represent a search query. The query conceptual graph may include graph terms that represent concept types. A set of terms conceptually similar to the graph terms may be identified and used to perform a search. In certain embodiments, system 10 generates a document conceptual graph that may represent a document. The document conceptual graph may include graph terms that represent concept types. A set of terms conceptually similar to the graph terms may be identified and used to represent the document. The conceptually similar terms of a document may be compared with conceptually similar terms of a search. The document may be selected as a result of the search if the terms match.

In the illustrated embodiment, system 10 includes a client 20, a server 24, and a memory 50. Server 24 includes a conceptual graph generator 30, a term expander 40, an onomasticon manager 45, a graph matcher 46, and a context generator 48. Memory 50 includes an ontology 51, an onomasticon 52, and documents 53.

A component of system 10 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In particular embodiments, client 20 may send input to system 10 and/or receive output from system 10. In certain embodiments, client 20 may be a remote client communicating with system 10 through a network. In particular examples, a user may use client 20 to send input to system 10 and/or receive output from system 10. In particular embodiments, client 20 may provide output, for example, display, print, or vocalize output, reported by server 24, such as by term expander 30, conceptual graph generator 40, graph matcher 46 and/or context generator 48.

In particular embodiments, client 20 may send an input search query to system 10. An input search query may comprise any suitable message comprising one or more query terms that may be used to search for documents 53, such as a keyword query, or concept query based on keywords representing a concept. A term may comprise any suitable sequence of characters, for example, one or more letter, one or more numbers, and/or one or more other characters. An example of a term is a word.

Server 24 stores logic (for example, software and/or hardware) that may be used to perform the operations of system 10. In the illustrated example, server 24 includes term expander 40, conceptual graph generator 30, onomasticon manager 45, graph matcher 46, and context generator 48.

In particular embodiments, conceptual graph generator 30 generates a conceptual graph 60. A conceptual graph may be a graph that represents concept types expressed as terms (for example, specific instances of concept types) and the relationships among the concept types. An example of a conceptual graph is described with reference to FIG. 2A.

FIG. 2A illustrates an example of a conceptual graph 60. Conceptual graph 60 includes nodes, such as concept nodes 61a, 62a, and/or 63a and conceptual relation nodes 64 and/or 65, coupled by arcs 67 (67a, 67b, 67c, and/or 67d). The nodes include graph terms. A concept node 61a, 62a, and/or 63a represents a concept, and may include a concept type and a concept referent, which may be a specific instance of a concept type. The concept type may specify a concept, and the referent may designate a specific entity instance of the concept type.

In the illustrated example, concept node 61a includes concept type 61 “Person” and concept referent 66a “?x”, which is an unknown concept referent. Concept node 62a includes concept type 62 “Make”, but no concept referent. Concept node 63a includes concept type 63 “Bomb”, and concept referent 66b “?y”, which is an unknown concept referent. Concept types may be expressed as subjects, direct objects, verbs, or any suitable part of language. In the illustrated example, concept type 61 is a direct object represented by term “Person”, concept type 62 is a verb represented by term “Make”, and concept type 63 is a subject represented by term “Bomb”. In some embodiments, “make” may be referred to as a “linking concept term” based on its function in the concept graph, and may provide a context between concept type “Person” and concept type “Bomb,” for example, indicating a “person” “make” “bomb”.

Conceptual relation nodes 64 and/or 65 represent relationships between concept nodes 61a, 62a, and/or 63a, and arcs 67 represent the direction of the relationships. In the illustrated example, conceptual relation node 64 “Agent” represents an agent relationship between concept nodes 61a and 62a. Arc 67a indicates that “Person:?x” is the agent of the action “Make”. Conceptual relation node 65 “THME” represents a theme relation between concept nodes 62a and 63a. Arc 67d indicates that “Bomb:?y” is the theme of the action “Make”.

In particular embodiments, the concepts and the relationships among the concepts of conceptual graph 60 may be expressed in text. In certain embodiments, square brackets may be used to indicate concept nodes 61a, 62a, and/or 63a, and parentheses may be used to indicate relation nodes 64 and/or 65. Hyphens and/or arrows may be used to indicate arcs 67. In the illustrated example, the concepts and relationships may be expressed as:

[Person: ?x]←(Agent)←[Make]→(THME)→[Bomb:?y]

Referring back to FIG. 1, in particular embodiments, conceptual graph generator 30 may generate a document conceptual graph 300 for a document. An example of a document conceptual graph 300 is described in more detail with reference to FIG. 2B.

FIG. 2B illustrates an example of a document conceptual graph 300. In the illustrated example, document conceptual graph 300 includes nodes, such as concept nodes 301a, 302a, and/or 303a and conceptual relation nodes 304 and/or 305, coupled by arcs 307 (307a, 307b, 307c, and/or 307d). In the illustrated example, concept node 301a includes concept type 301 “Person” and concept referent 306a “John Doe”. Concept node 302a includes concept type 302 “Make”, but no concept referent. Concept node 303a includes concept type 303 “Bomb”, and concept referent 306b “Car bomb”.

In the illustrated example, conceptual relation node 304 “Agent” represents an agent relationship between concept nodes 301a and 302a. Arc 307a indicates that “Person: John Doe” is the agent of the action “Make”. Conceptual relation node 305 “THME” represents a theme relation between concept nodes 302a and 303a. Arc 307d indicates that “Bomb: Car bomb” is the theme of the action “Make”. In some embodiments, “Make” may be referred to as a “linking concept term” based on its function in the concept graph.

In the illustrated example, the concepts and relationships of document conceptual graph 300 may be expressed as:

[Person: John Doe]←(Agent)←[Make]→(Theme)→[Bomb: Car bomb]

In the illustrated example, document conceptual graph 300 may represent some or all of a retrieved document that includes information about “Person (specified as John Doe) “Makes” a “Bomb” (specified as Car bomb).”

Referring back to FIG. 1, conceptual graph generator 30 may perform other suitable operations. In particular embodiments, conceptual graph generator may include an entity extractor that can extract concept types and/or referents to construct graphs.

In particular embodiments, term expander 40 expands terms representing concept types of conceptual graph 60 and/or 300. Term expander 40 may expand the terms by identifying, for each term, a set of terms conceptually similar to the term. Term expander 40 may use an ontology 51 to identify the conceptually similar terms. A search query may be formed using the conceptually similar terms. Term expander 40 may include a Raytheon Semantic Reverse Query Expander, or other term expander. Term expander 40 may also include a logic engine for reasoning about terms and their suitability. An example of a logic engine may include Cyc.

Conceptually similar terms may be terms that are, for example, within the semantic context of each other. Examples of conceptually similar terms include synonyms, hypemyms, holonyms, hyponyms, merronyms, coordinate terms, verb participles, troponyms, and entailments. Conceptually similar terms may be in the native language of the search (for example, English) and/or a foreign language (for example, Arabic, French, or Japanese). In one embodiment, a foreign language term may be a foreign language translation of a native language term related to a conceptual graph.

A conceptually similar term (CST) of a term may be expressed as CST (term). For example, CST (Person) is Human.

In the illustrated example, examples of conceptually similar terms for query concept graph and/or 300 may be as follows:

CST(Person): Individual, Religious individual, Engineer, Warrior, etc.

CST(Make): Building, Build, Create from raw materials, etc.

CST(Bomb): Explosive device, Car bomb, Pipe bomb, etc.

The conceptually similar terms may include the following Arabic terms (English translation in parentheses):

CST(Person): [symbol] (Person), [symbol] (Individual), [symbol] (Religious individual), [symbol] (Engineer), [symbol] (Warrior), etc.

CST(Make): [symbol] (Make), [symbol] (Building), [symbol] (Build), [symbol] (Create from raw materials), etc.

CST(Bomb): [symbol] (Bomb), [symbol] (Explosive device), [symbol] (Car bomb), [symbol] (Pipe bomb), etc.

In particular embodiments, onomasticon manager 45 manages onomasticon 52. Onomasticon manager 45 may manage information in onomasticons 52 by performing any suitable information management operation, such as storing, modifying, organizing, and/or deleting information. In particular embodiments, onomasticon manager 45 may perform the following mappings: a query conceptual graph to a search query, a set of conceptually similar terms to a concept type of a conceptual graph, a set of conceptually similar terms to a search query, a word sense of conceptually similar terms to a concept type, and/or a set of conceptually similar terms to a word sense. Onomasticon manager 45 may perform the operations at any suitable time, such as when information is generated or validated.

In particular embodiments, graph matcher 46 may compare query conceptual graphs 60 and document conceptual graphs 300 to see if graphs 60 and 300 match in order to select documents that match the search query. In particular embodiments, expanded document conceptual graphs 300 and expanded query conceptual graphs 60 may be compared.

Graphs may be regarded as matching if one, some, or all corresponding terms associated with the graphs match. Terms associated with a graph may include terms representing concept types of the graph and/or terms that are conceptually similar to the terms representing the concept types. Corresponding concept nodes may be nodes in the same location of a graph. For example, node 61a of graph 60 corresponds to node 301a of graph 300.

In the example, nodes 61a, 62a, 63 a, 64, and/or 65 of conceptual graph 60 may match nodes 301a, 302a, 303a, 304, and/or 305 of conceptual graph 300 if the concept types and/or relations of nodes 61a, 62a, 63a, 64, and/or 65 match that of nodes 301 a, 302a, 303a, 304, and/or 305, respectively. In the example, conceptual graphs 60 and 300 may be regarded as matching.

In particular embodiments, graph matcher 46 may validate a match using onomasticons 52. In certain examples, graph matcher 46 may determine whether conceptually similar terms of graphs 60 and 300 map to the same concept type in one or more onomasticons 52. If they do, the match may be regarded as valid. In certain examples, the conceptually similar terms of graphs 60 and 300 may be in the same or different onomasticons 52.

In particular embodiments, if a document conceptual graph 300 representing a document 53 matches query conceptual graphs 60, graph matcher 46 may select document 53 to report to client 20.

In particular embodiments, context generator 48 may be used to retrieve referents for concept types 301 and 303. Context generator 48 identifies concept type “Make” as a context between the concept types “Person” and “Bomb”. In Memory 50, any concept types containing “Person” and “Bomb”, or specific terms to represent these concept types, such as “Individual” for “Person” and “Package Bomb” for “Bomb”, with the relationship “Make”, or specific terms representing “Make” for example “Build”, the referents, such as “John Doe” for concept type “Person”, and “UPS Bomb” for concept type “Bomb” are mapped to the concept types 61 and 63 respectively in concept graph 60. The mapping is stored in Onomasticon 52 for possible use by graph matcher 46 or by system 10.

Memory 50 includes ontology 51, onomasticon 52, and documents 53. Ontology 51 stores terms, attributes of terms, word senses (or definitions) of terms, and relationships among the terms. Ontology 51 may be used (for example, by term expander 40) to determine the appropriate terms, attributes, and relationships. For example, ontology 51 may describe the semantically related terms of a term and the relationships that the term may have with other terms. Relationships may include such as synonyms, hypemyms, holonyms, hyponyms, merronyms, coordinate terms, verb participles, troponyms, and entailments. For example, ontology 51 may store the conceptually similar terms for “Person”, “Make”, and “Bomb” as described above. Ontology 51 may include one or more knowledge bases (KB), knowledge stores (KS) or databases (DB).

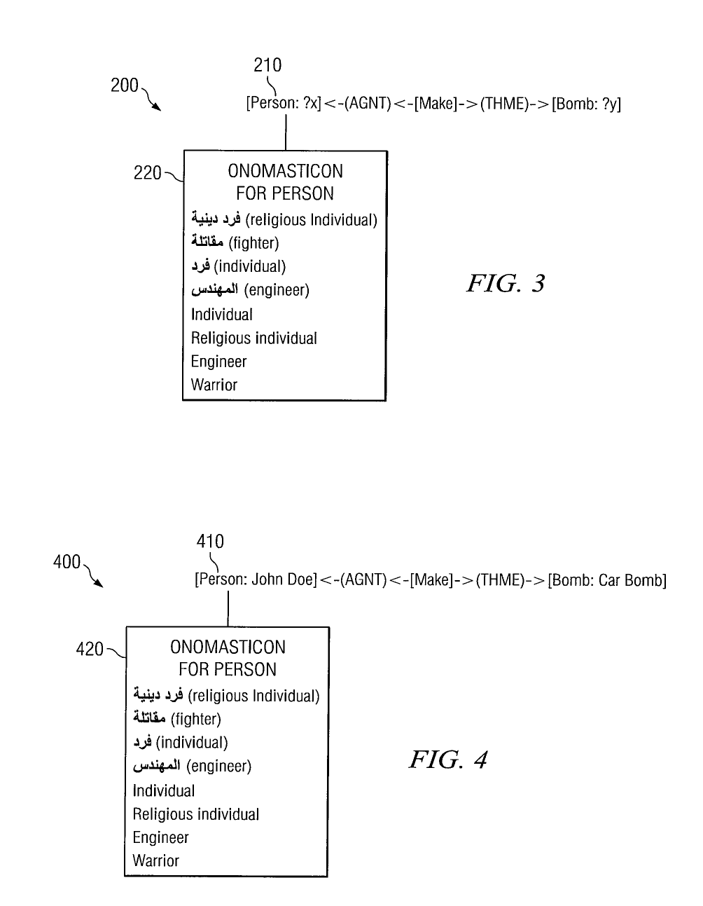

Onomasticon 52 records information resulting from the operations of system 10 in order to build a knowledge base of conceptually similar terms to represent concept types found in conceptual graphs. Onomasticon 52 may store mappings of the conceptually similar terms to the concept types. In particular embodiments, information in onomasticon 52 may be used for future searches. For example, term expander 40 may retrieve conceptually similar terms mapped to a term from onomasticon 52. FIGS. 3 and 4 illustrate examples of onomasticons 52.

FIG. 3 illustrates an example of an onomasticon 220 that may be used for a query conceptual graph 60. Onomasticon 220 stores conceptually similar English and foreign language terms, such as Arabic terms, for the concept type [Person] 210. These terms may include Individual, Religious individual, Engineer, Warrior, [symbol] (Individual), [symbol] (Religious individual), [symbol] (Engineer), and [symbol] (Fighter).

FIG. 4 illustrates an example of an onomasticon 420 that may be used for a document conceptual graph 300. Onomasticon 420 stores conceptually similar English and foreign language terms, such as Arabic terms, for the concept type [Person] 410. These terms may include Individual, Religious individual, Engineer, Warrior, [symbol] (Individual), [symbol] (Religious individual), [symbol] (Engineer), and [symbol] (Fighter).

Referring back to FIG. 1, a document 53 may refer to a collection of terms (such as words), and may be stored electronically. Documents 53 may include documents in a native language and/or a foreign language.

In the operation of system 10, sometimes referents to concept types and term representations for concept types (e.g., conceptually similar terms) in query conceptual graphs may be left undefined. For an exact query of a specific instance of a concept, referent information may be needed to discover instance information in a potential query return. Accordingly, some embodiments provide for determining referents for specific concept types.

Similarly, sometimes referents to concept types and term representations for concept types in query return conceptual graphs may be left undefined. For an exact match of a query referent and referent in a query return, referents in a potential query return must be determined. Accordingly, certain embodiments provide for determining referents for specific concept types in a query return. Embodiments also provide for storage and future use of determined referents by system 10, such as to match query with information in query returns, execute future queries, and/or discover specific instances of concepts.

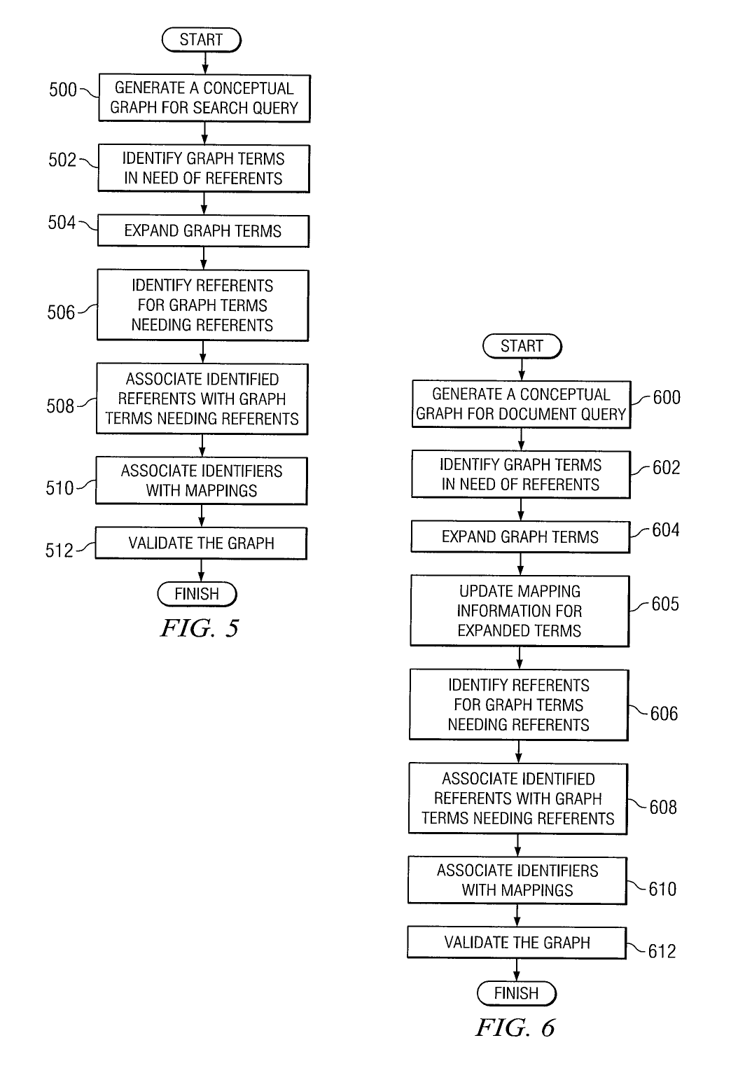

FIG. 5 illustrates an example of a method for determining referents of a query concept type utilizes term expander 40 and conceptual graph generator 30 to create a conceptual graph and expand concept types.

At step 500, a conceptual graph for a search query may be generated by system 10. The graph may be generated automatically, or in response to a user input. For example, the generated query conceptual graph may be:

[Person: ?x]←(AGNT)←[Make]→(THME)→[Bomb:?y]

At step 502, graph terms in need of referents are identified. The identification may be performed based on properties of the conceptual graph, either automatically or by a user. Additionally, a context may be assigned to the concept types contained in all possible conceptual graphs produced by conceptual graph generator 30 by context generator 48. For example, in the above example, “make” is identified as the prime linking concept, linking the concept object types “person” and “bomb.” In this example, “Person:?X” and “Bomb:?Y” are identified as concept type objects in need of referents. Note that “prime linking concept” and “prime linking object” are used interchangeably in the disclosure.

At step 504, graph terms are expanded. Expanded concept types may be generated for each node. For example, “person” may be expanded to “individual,” “religious person,” “human,” and “warrior.” “Make” may be expanded to “made,” “create,” “build,” and “assemble.” “Bomb” may be expanded to “explosive device,” “car bomb,” and “package bomb.” Terms may be expanded by referencing mappings in onomasticon 52, or by other appropriate methods, such as by utilizing ontology 51. The expanded terms that represent the concept types in conceptual graphs are stored along with mapping information in onomasticon 52. Onomasticon 52 may store terms and their mappings to concept types in specific concept graphs.

Expansion may require identifying term representations or conceptually similar terms for a term. Conceptually similar terms for a term may be identified by determining a semantic sense for each graph term and the linking concept identifying the conceptually similar terms in accordance with the semantic senses. The semantic sense may be determined from the meaning of the term or terms. For example, conceptual graph generator 30 reports terms representing concept types of conceptual graph 200 to term expander 40. Term expander 40 retrieves word sense options for one or more terms from ontology 51. A word sense may indicate the use of a term in a particular semantic context. In the example, for the term “bomb”, the word sense options may include “to bomb a test” and “to detonate a bomb.” A word sense may be selected from the word sense options automatically or by a user. A selected word sense is received by term expander 40, and onomasticon manager 45 may map the selected word sense to the concept type and store the mapping in onomasticon 52. Term expander 40 may report conceptually similar term options based on the selected word sense. In some embodiments, the conceptually similar term options may be retrieved from onomasticon 52. In the example, the similar terms “bomb” may include “Bomb” may be expanded to “explosive device,” “car bomb,” and “package bomb.” One or more conceptually similar terms may be selected (by a user or automatically) from the conceptually similar term options. Conceptually similar terms may include foreign language terms comprising a foreign language translations of a native language term conceptually similar to the search query.

In certain embodiments, mapping information for expanded terms is updated or otherwise modified. For example, Mapping information in onomasticon 52 for expanded prime linking concept terms (e.g., term representations of “make”) is appended or modified to identifying the terms as “prime linking concepts.” For example, “make” may be expanded to “made,” “create,” “build,” and “assemble.” Mapping information for each of those expanded terms is modified so that each terms is identified as a “prime linking concept.” Similarly, mapping information in onomasticon 52 for expanded concept type object terms (e.g., terms representations for “individual” and “package bomb”) is appended to identify each term as a “concept types in need of referents.”

At step 506, referents for graph term in need of referents are identified. Referents may be identified, for example, by searching for instances where conceptually similar terms for graph terms in need of referents are associated by conceptually similar terms for the linking concept term.

In certain embodiments, mapping information for terms representing “make” in onomasticon 52 may be appended or modified to identify such terms as “prime linking context.” Mapping information for terms representing “person” and “bomb” may be appended or modified to identify the terms as “concept type objects in need of referents.”

Each term representation of a concept type object in need of referents contained in onomasticon 52 may be used to search ontology 51 for matching nodes or elements. Terms representing the concept type identified as the prime linking concept (in the example above, “make”), are used to search relationship data in ontology 51. When term representations for concept types in need of referents are identified and found to be associated with contain term representations for concept types for the prime context linking concept as a relationship, instance data in ontology 51 is retrieved. In certain embodiments, term representations for concept types needing referents are identified, and ontology 51 is searched for matches wherein term representations for the linking concepts are associated with the term representations for the concept types. For each match, instance data may be retrieved.

For example, “package bomb” is a term representation for concept type object “bomb.” “Individual” is a term representation for concept type object “person.” The concept types objects are linked by the linking concept term “make.” If ontology 51 contains nodes “package bomb” and “individual,” and “package bomb” has an “is made by” linking relationship to “individual,” instance data for “package bomb” and “individual” would be retrieved. For example, “unibomber” may be instance data for “individual,” and “UPS package” may be instance data for “package bomb.” The instance data would be considered referents for concept types in conceptual graphs. The resulting conceptual graph with referents might be:

[individual: unibomber]←(AGNT)←[Made]→(THME)→[Package bomb: UPS package]

At step 508, identified referents may be associated with the graph terms in need of referents. For example, mappings in onomasticon 52 associated with “individual” and “package bomb” may be updated with referent data. In the example, “unibomber” and “package bomb” mappings may be updated to include “individual” and “package bomb,” respectively. In some embodiments, mapping information may utilize a binding of system choice (e.g., XML, RDF, RDFS, OWL Lite, Full OWL, KIF, DAML, OIL, DAML+OIL, etc.).

At step 510, identifiers may be associated with the mappings or instance data. For example, mapping information in onomasticon 52 for all referents representation(s) stored may include a unique ID of the query (e.g., obtained from term expander 40), a unique ID of the conceptual graph (e.g., obtained conceptual graph generator 30), a unique ID of the concept type (e.g., obtained from conceptual graph generator 30), a unique ID of the term representing the concept type (e.g., obtained from onomasticon 52), and/or the unique ID of the query return (e.g., obtained from a data store containing the query return).

At step 512, the conceptual graph may be validated based on the identified referents. In certain embodiments, a logic engine may be used to determine the validity of conceptual graphs by utilizing referents. If the logic engine determines a conceptual graph is invalid for any referents of concept types within the conceptual graph, the referents and/or any mapping information such as unique IDs described above may be removed from onomasticon 52.

Modifications, additions, or omissions may be made to the method without departing from the scope of the invention. The method may include more, fewer, or other steps. Additionally, steps may be performed in any suitable order.

FIG. 6 illustrates a method for determining referents of query return concept types utilizes term expander 40 and conceptual graph generator 30 to create a conceptual graph and expand concept types.

At step 600, a conceptual graph is generated from one or more documents returned from a query. An entity extractor (e.g., NetOwl) may be utilized to extract referents to the conceptual graphs generated by the conceptual graph generator 30. For example, a conceptual graph generated from returned documents may be:

[Individual:?x]←(AGNT)←[Make]→(THME)→[Package Bomb:?y]

Specific instance data may be extracted from the document related to the concept type in the conceptual graph and/or the terms representing concept types.

At step 602, graph terms in need of referents are identified. As explained in reference to FIG. 5, a context may be assigned to the concept types contained in all possible conceptual graphs produced by a conceptual graph generator 30. Thus, “make” is identified as the prime linking concept, linking the concept type objects “individual” and “package bomb.” Additionally, “individual: ?x” and “package bomb: ?y” are identified as concept type objects in need of referents.

At step 604, graph terms are expanded. As explained above with reference to FIG. 5, terms may be expanded by identifying a semantic sense and/or conceptually similar terms. The concept types in the graph, including the prime linking concept, may be expanded. For example, “individual” may be expanded to “person,” “religious person,” “human,” and “warrior.” “Make” may be expanded to “made,” “create,” “build,” and “assemble.” “Bomb” may be expanded to “explosive device,” “car bomb,” and “package bomb.” Terms may be expanded by referencing mappings in onomasticon 52, or by other appropriate methods, such as by utilizing ontology 51. The expanded terms that represent the concept types in conceptual graphs may be stored along with mapping information in onomasticon 52. Onomasticon 52 may store terms and their mappings to concept types in specific concept graphs. Expansion details discussed above in reference to FIG. 5 are applicable.

At step 605, mapping information for expanded terms is updated or otherwise modified. For example, Mapping information in onomasticon 52 for expanded prime linking concept terms (e.g., term representations of “make”) is appended or modified to identifying the terms as “prime linking concepts.” For example, “make” may be expanded to “made,” “create”, “build,” and “assemble.” Mapping information for each of those expanded terms is modified so that each terms is identified as a “prime linking concept.” Similarly, mapping information in onomasticon 52 for expanded concept type object terms (e.g., terms representations for “individual” and “package bomb”) is appended to identify each term as a “concept types in need of referents.”

At step 606, referents for graph terms needing referents are identified. Each concept type in need of referents and prime linking concept term contained in onomasticon 52 is used to retrieve instance data from the query returns. Referents may be identified by searching documents for instances where conceptually similar terms for graph terms in need of referents are associated by conceptually similar terms for the linking concept term.

For example, assume that “package bomb” and “individual” are concept type objects contained in a query return, and “make” is a prime linking concept term in the query return. Conceptual graph generator 30 searches documents 53 for any “make” or term representation for the concept type “make” as a linking relationship between the concept type objects “individual” and “package bomb.” If the relationship exists, the conceptual graph generator 30 extracts the relevant instance data and includes the instance data in a conceptual graph. For example, if conceptual graph generator 30 found “unibomber” as an instance of “individual” in a query return document and also found “UPS package” as an instance of “package bomb” in the query return document, a resulting conceptual graph with referents would be:

[Individual: Unibomber]←(AGNT)←[Made]→(THME)→[Package bomb: UPS package]

At step 608, identified referents are mapped or otherwise associated with graph terms needing referents. Mappings in onomasticon 52 for “individual” and “package bomb” may be updated accordingly. In the example, “Unibomber” and “UPS package” mappings may be updated to include “individual” and “package bomb,” respectively. Mapping information in onomasticon 52 for all referents representation(s) stored may include a unique ID of the query (e.g., obtained from term expander 40), a unique ID of the conceptual graph (e.g., obtained conceptual graph generator 30), a unique ID of the concept type (e.g., obtained from conceptual graph generator 30), a unique ID of the term representing the concept type (e.g., obtained from onomasticon 52), and/or the unique ID of the query return (e.g., obtained from a data store containing the query return). In some embodiments, mapping information may utilize a binding of system choice (e.g., XML, RDF, RDFS, OWL Lite, Full OWL, KIF, DAML, OIL, DAML+OIL, etc.).

At step 610, identifiers may be associated with the mappings or instance data. For example, mapping information in onomasticon 52 for all referents representation(s) stored may include a unique ID of the query (e.g., obtained from term expander 40), a unique ID of the conceptual graph (e.g., obtained conceptual graph generator 30), a unique ID of the concept type (e.g., obtained from conceptual graph generator 30), a unique ID of the term representing the concept type (e.g., obtained from onomasticon 52), and/or the unique ID of the query return (e.g., obtained from a data store containing the query return).

At step 612, the updated graph, or other graphs, may be validated based on the updated referent mappings. Certain embodiments utilize a logic engine to determine the validity of a graph. A logic engine such as Cyc may be utilized, or any suitable method for validation.

Modifications, additions, or omissions may be made to the method without departing from the scope of the invention. The method may include more, fewer, or other steps. Additionally, steps may be performed in any suitable order.

Although FIG. 5 and FIG. 6 are discussed individually, many concepts, processes, and methods are common to each, and certain portions described with reference to one may also apply to the other. Also note that although English language examples are utilized above in various embodiments, certain embodiments provide for determining referents of a query concept type in foreign languages. Such embodiments may include a translator and various foreign language data.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A computer-implemented method for determining query referent data for concept types in a conceptual graph comprising:
generating a conceptual graph for a search query, the conceptual graph comprising a plurality of graph terms;
identifying at least one graph term needing referent data;
for each graph term needing referent data, identifying referent data by searching for instances where conceptually similar terms for graph terms needing referent data are associated by conceptually similar terms for a linking concept term; and
associating identified referent data with the graph terms needing referent data.

2. The method of claim 1, further comprising storing a unique identifier for the query and a unique identifier for an ontology associated with the instance data.

3. The method of claim 1, further comprising validating the conceptual graph based on the identified referent data.

4. The method of claim 1, wherein identifying one or more conceptually similar terms for each graph term and the linking concept further comprises:
determining a semantic sense for each graph term and the linking concept; and
identifying the conceptually similar terms in accordance with the semantic senses.

5. The method of claim 1, wherein the set of conceptually similar terms comprises at least one foreign language term comprising a foreign language translation of a native language term conceptually similar to the search query.

6. A system for determining query referent data for concept types in a conceptual graph comprising:
a memory configured to store a conceptual graph for a search query, the conceptual graph comprising a plurality of graph terms and a linking concept term; and
logic stored in one or more tangible media and when executed by a computer configured to:
generate a conceptual graph for a search query, the conceptual graph comprising a plurality of graph terms;
identify at least one graph term needing referent data;
for each graph term needing referent data, identify referent data by searching for instances where conceptually similar terms for graph terms needing referent data are associated by conceptually similar terms for a linking concept term; and
generate a mapping associating identified referent data with the graph terms needing referent data.

7. The system of claim 6, wherein the logic is further configured to store a unique identifier for the query and a unique identifier for an ontology associated with the instance data.

8. The system of claim 6, wherein the logic is further configured to store validate the conceptual graph based on the identified referent data.

9. The system of claim 6, wherein identifying one or more conceptually similar terms for each graph term and the linking concept further comprises: determining a semantic sense for each graph term and the linking concept; and identifying the conceptually similar terms in accordance with the semantic senses.

10. The system of claim 6, wherein the set of conceptually similar terms comprises at least one foreign language term comprising a foreign language translation of a native language term conceptually similar to the search query.

11. A computer-implemented method for determining query referent data for concept types in a conceptual graph comprising:
generating a conceptual graph for a search query, the conceptual graph comprising a plurality of graph terms including a first concept type object, a second concept type object, and a linking concept associating the first concept type object and second concept type object;
identifying a plurality of first concept type object term representations, a plurality of second concept type object term representations, and a plurality of linking concept term representations;
searching a knowledge base for an instance where one of the first concept type object term representations is associated with one of the second concept type object term representations by one of the linking concept term representations;
extracting referent data for the first concept type object and the second concept type based on an identified instance;
updating the conceptual graph to include the referent data; and
based on the referent data, updating one or more mappings for the first concept type object and the second concept type object.

12. The method of claim 11, further comprising associating a unique identifier for the search query with updated mappings.

13. The method of claim 11, further comprising validating the conceptual graph based on the referent data.

14. The method of claim 11, wherein identifying a plurality of first concept type object term representations, a plurality of second concept type object term representations, and a plurality of linking concept term representations further comprises:
determining a semantic sense for the first concept type object, the second concept type object, and the linking concept term; and
identifying conceptually similar terms in accordance with the semantic senses.

15. The method of claim 11, wherein the plurality of first concept type object term representations, the plurality of second concept type object term representations, and the plurality of linking concept term representations each comprise at least one foreign language term comprising a foreign language translation of a native language term conceptually similar to the search query.

16. A system for determining query referent data for concept types in a conceptual graph comprising:
a memory configured to store a conceptual graph for a search query, the conceptual graph comprising a plurality of graph terms and a linking concept term; and
logic stored in one or more tangible media and when executed by a computer configured to:
generate a conceptual graph for a search query, the conceptual graph comprising a plurality of graph terms including a first concept type object, a second concept type object, and a linking concept associating the first concept type object and second concept type object;
identify a plurality of first concept type object term representations, a plurality of second concept type object term representations, and a plurality of linking concept term representations;
search a knowledge base for an instance where one of the first concept type object term representations is associated with one of the second concept type object term representations by one of the linking concept term representations;
extract referent data for the first concept type object and the second concept type based on an identified instance;
update the conceptual graph to include the referent data; and
based on the referent data, update one or more mappings for the first concept type object and the second concept type object.

17. The system of claim 16, the logic further configured to associate a unique identifier for the search query with updated mappings.

18. The system of claim 16, the logic further configured to validate the conceptual graph based on the referent data.

19. The system of claim 16, wherein identifying a plurality of first concept type object term representations, a plurality of second concept type object term representations, and a plurality of linking concept term representations further comprises:
determining a semantic sense for the first concept type object, the second concept type object, and the linking concept term; and
identifying conceptually similar terms in accordance with the semantic senses.

20. The system of claim 16, wherein the plurality of first concept type object term representations, the plurality of second concept type object term representations, and the plurality of linking concept term representations each comprise at least one foreign language term comprising a foreign language translation of a native language term conceptually similar to the search query.
